(19) United States
(12) Patent Application Publication
(10) Pub. No.: US 2025/0189296 A1
(43) Pub. Date: Jun. 12, 2025

(54) NON-CONTACT OPTICAL METROLOGY SYSTEM TO MEASURE SIMULTANEOUSLY THE RELATIVE PISTON AND THE RELATIVE INCLINATION IN TWO AXES (TIP AND TILT) BETWEEN TWO REFLECTIVE SURFACES

(71) Applicant: IDOM, S.A.U., BILBAO-BIZKAIA (ES)

(72) Inventors: Gaizka MURGA LLANO, BILBAO-BIZKAIA (ES); Rubén SANQUIRCE GARCIA, BILBAO-BIZKAIA (ES); Alexander DIAZ CASTILLO, BILBAO-BIZKAIA (ES); Maialen GONZALEZ JAIO, BILBAO-BIZKAIA (ES); Elena LARA SAEZ, BILBAO-BIZKAIA (ES); Josep ARASA MARTI, BILBAO-BIZKAIA (ES); Santiago ROYO ROYO, BILBAO-BIZKAIA (ES); Carles PIZARRO BONDIA, BILBAO-BIZKAIA (ES); Noél RODRIGO ARCAY, BILBAO-BIZKAIA (ES); Pau SANTOS VIVES, BILBAO-BIZKAIA (ES); Manuel Enrique ROLDAN NARVION, BILBAO-BIZKAIA (ES); Francisco Javier CASTRO LOPEZ-TARRUELLA, BILBAO-BIZKAIA (ES)

(73) Assignee: IDOM, S.A.U., BILBAO-BIZKAIA (ES)

(21) Appl. No.: 18/847,516

(22) PCT Filed: Mar. 16, 2022
(86) PCT No.: PCT/EP2022/056812

§ 371 Date: Sep. 16, 2024

(51) Int. Cl. G01B 9/02015; G01B 11/26

(52) U.S. Cl. CPC G01B 9/02016; G01B 9/02028; G01B 11/26

(57) ABSTRACT

A non-contact optical metrology system to measure simultaneously the relative piston and the relative inclination in two axes between two low curvature reflective surfaces using partially coherent light interferometry. The system creates an interference pattern with partially coherent light from the linear phase change induced by a double prism system or equivalent, which allows the measurement of the relative piston and the inclination in two axes between the reflective surfaces. The relative piston between the mirrors is measured from the position of the interference pattern, the relative inclination in one axis from the distance between the fringes, and the relative inclination in the other axis from the inclination of the fringes. Relative piston measurements and relative inclination measurements in two axes are decoupled and can be extracted with simple morphological operations, without the need for marginal processing algorithms.

### TECHNICAL FIELD

The invention is encompassed within the metrology sector. More specifically, it is encompassed within optical metrology, in order to measure, without contact and simultaneously, the relative piston and the relative inclination in two axes (tip and tilt) between two low curvature reflective surfaces using partially coherent light interferometry.

This optical measurement system is particularly applicable when it comes to measuring the difference in relative height (piston) between the segments of the primary mirror of the Extremely Large Telescope (ELT) which, with 39 metres of primary mirror, will be the largest optical telescope in the world.

The proposed system creates an interference pattern using partially coherent light from a linear phase change induced by a double prism system or equivalent. The relative piston between the mirrors can be measured through the position of the interference pattern, the relative inclination in one axis (tip) through the distance between the fringes, and the relative inclination in the other axis (tilt) through the inclination of the fringes. Relative piston measurements and relative inclination measurements in two axes (tip and tilt) are decoupled and can be extracted with simple morphological operations, without the need for fringe processing algorithms.

### STATE OF THE ART

Since they were invented in the 16th century, telescopes have evolved with constant increases in primary mirror diameter, as using larger primary mirrors increases both the light gathering power and the angular resolution of a telescope. Historically, an increasingly larger telescope was obtained by simply enlarging the diameter of the mirror, but as this was made from a single piece of glass, a limit was reached when mirrors larger than 8 m in aperture were needed. This dimensional barrier became unattainable basically due to the large mass required and the difficulties involved in the process of calculating and manufacturing mirrors of this size. It was for this reason that the development of segmented primary mirrors in the construction of large telescopes was carried out in the early 1980s.

A segmented mirror is composed of a number of smaller mirrors, called segments, arranged like a mosaic so that they all work together to provide image quality and aperture equivalent to a large monolithic mirror. However, segmented mirrors present a major problem in achieving proper positioning of the segments, since they must be aligned with a precision in the order of a fraction of a wavelength for telescope performance close to the diffraction limit in the visible/infrared, equivalent to a few tens of nanometres.

However, some problems arise due to segmentation, one of them being the proper relative positioning of each segment with respect to the adjacent segments, which requires in the design and construction of large ground-based telescopes an external calibration system that measures the relative misalignment of the segment, which can be corrected using a set of actuators located below each segment. There are two types of out-of-plane segment misalignments: vertical displacement (called piston) and inclinations in two axes (called tip and tilt).

Angular misalignments are usually measured with deflectometric wavefront sensors, e.g. Shack-Hartmann sensors; several techniques have also been proposed for the measurement of vertical discontinuities in pistons, among which the proposal by one of the inventors of this system that uses interferometry techniques to measure the vertical misalignment of segments (piston error) in segmented mirrors should be mentioned. This technique is based on a high-aperture Michelson interferometer that uses a broadband light spectrum, with fibre optic illumination that allows the measurement of piston error during the day with an uncertainty of 5 nm in a range of 30 μm.

The Mach-Zehnder interferometer is also well known in the state of the art. It is an instrument that makes it possible to accurately determine the relative phase change variations between two collimated light beams derived from the same light source. For this reason, this interferometer has been used, among others, to measure phase changes between the two light beams, caused by the observed sample or by a change in the length of one of the paths they travel. It is important to understand the operation of such an interferometer that when light incides on a surface, the reflected light is displaced by exactly half a wavelength if the material on the other side of the surface has a higher refractive index. If the refractive index of this material is lower, then there is no phase change in the reflected beam. And when light travels from one medium to another, there is also no phase change, but the direction of the beam changes due to refraction.

The Mach-Zehnder interferometer is a device used to take precise optical measurements. It can demonstrate interference by splitting a light beam in two and measuring the phase changes between the two beams. The basic components of the interferometer are a light source, two beam splitters, two mirrors, and two detectors. The beam splitter is often a half-silvered mirror that transmits part of the light beam and reflects the rest. Light from an illumination source, typically a laser, strikes a beam splitter, which splits the light into two beams of equal intensity, going in different directions and hitting the two mirrors. The phase of each light beam changes due to its contact with the mirror surface. The beams are recombined in the second beam splitter, and the detectors help in the study of phase differences in light paths. An alternative arrangement has the recombined beams pass through a positive lens, causing the beams to focus at a single point. If all the reflective surfaces are aligned in such a way that they are absolutely parallel, no interference fringes are produced when the beams are recombined. However, if the angles of the mirror surfaces differ even slightly, the recombined beams produce interference fringes. The interference fringe pattern produced by the Mach-Zehnder interferometer will show dark and bright lines that vary in intensity.

The challenge that the present invention proposes to overcome is to be able to measure the relative height difference (piston), as well as the relative inclination in two axes (tip and tilt), between two reflective optical surfaces such as the segments of the primary mirror that make up the ELT's main mirror, which is the centrepiece of the revolutionary astronomical machine currently being built in Chile's Atacama desert. It is an element too large to be made from a single piece of glass since it will be 39 metres in diameter and therefore will consist of 798 segments, each about 5 centimetres thick, which will measure close to 1.5 metres wide and weigh 250 kg, including the support thereof. Since the segments have to work together as a single mirror, they require specific infrastructure and control schemes. This is extremely challenging as the entire structure will be constantly moving during an observation and affected by wind and thermal changes. To achieve the required scientific performance, the mirror must be held in position and shape with a precision of tens of nanometres across its entire 39-metre diameter. Therefore, it is strictly necessary to measure the relative height difference (piston) between the segments with extreme precision.

### DESCRIPTION OF THE INVENTION

Based on the prior art, an objective of the present invention is to provide an optical metrology system that solves a basic problem in metrology for high spatial resolution measurement of large structures with an extreme degree of precision.

In order to achieve the proposed objectives mentioned in the previous section, the invention proposes a non-contact optical metrology system to measure simultaneously the relative piston and the relative inclination in two axes (tip and tilt) between two reflective surfaces, which has the features of claim 1.

The invention proposes introducing in a Mach-Zehnder interferometer two significant changes:
an optical element that causes a linear optical path difference (measurement tilt) in the optical beam is interposed in the target arm; and
a compensation plate is interposed in the reference path in order to balance the two arms of the interferometer by centering the interference pattern.

The interferometer thus described fed with partially coherent light generates a fixed interference pattern modulated by an amplitude envelope, in which only the fringes close to the region in which the optical path difference in the two arms of the interferometer is zero, will be visible; so that when projecting said interference pattern in a camera, the three magnitudes measured are decoupled, so they can be extracted with simple morphological operations. These three magnitudes are represented by:
the relative piston by the position of the envelope of the interference pattern fringe,
the relative inclination in one axis (tip) by the separation of the fringes, and
the relative inclination in the other axis (tilt) by the inclination of the fringes.

In a preferred embodiment, the optical component interposed in the target arm to generate the linear optical path difference (measurement tilt) is a double prism, made up of two optical glasses with different but close refractive indices depending on the resolution sought to be achieved. However, other alternative embodiments are possible, for example using a wedge prism or even generating the same optical path difference by slightly inclining one or more of the beam splitters relative to each other. In any case, either with this optical component or with the inclination of a beam splitter, an interference pattern the displacement of which is proportional to the piston displacement present in the system, between the target surface and the reference surfaces, is generated.

In this system, the measurement resolution values are a function of the degree of coherence of the light source used.

As will be explained later, the compensation plate can also adopt a stepped configuration in several different regions to introduce a constant path difference jump between said regions, in order to establish several correlative piston measurement zones in the detector, generating different measurement zones in the detector. The final result is an image with different horizontal bands along the X direction where the piston value linearly displaces the OPD=0 region and subsequently the interference pattern.

A solution to be able to measure the absolute value of inclination in two axes (tip and tilt) of the interferometer with respect to the reference surface will also be detailed later. This measure allows the interferometer to be properly aligned to avoid measurement errors induced by the inclination of the interferometer.

The most significant advantage of this configuration is that the relative piston measurement is performed without the need to perform a fringe reconstruction, but only from the position of the partial coherence interferogram in the detector. This enables fast and reliable image processing algorithms, eliminates the need for complex fringe processing, is less prone to be affected by noise, and reduces piston measurement to morphological operations on the image.

Other advantages of the proposed measurement concept include the following:
it is self-referenced, which avoids the need for long compensation paths within the unit and allows short-range operation,
the interferometer is capable of measuring from a single interferogram not only the relative piston between its two arms, based on the position of the modulation pattern, but also the relative inclination in two axes: tip, based on the width of the modulation pattern, and tilt, based on the inclination of the fringes-,
relative piston and relative inclination in two axes (tip and tilt) are decoupled and can be extracted with simple morphological operations, without the need for fringe processing algorithms,
the degree of coherence of the light can be adapted, which allows an additional degree of freedom,
most system components could be completely commercial,
there is no need for active or complex elements which decalibrate, add complexity or need light polarization control,
it is based on simple and well-known building blocks that allow refinement throughout development on various parameters (source bandwidth, magnification, etc.) resulting in a flexible configuration with potential for optimization at later stages, and
the approach is computationally simple and can take advantage of current state-of-the-art embedded computing units, which are low cost and provide more computing power than is needed for the application.

### DESCRIPTION OF THE DRAWINGS

As a complement to the description being made, and for the purpose of helping to make the features of the invention more readily understandable, the present specification is accompanied by a set of drawings which, by way of illustration and not limitation, represent the following:

FIG. 1 is a schematic representation of a possible implementation of the invention.

FIGS. 2A and 2B show in pseudocolour the expected displacement of the fringe pattern caused by relative movement of the piston between the target and reference surfaces.

FIGS. 3A and 3B show in pseudocolour the expected broadening of the fringe pattern caused by a relative inclination in one axis (tip) between the target and reference surfaces.

FIGS. 4A and 4B show in pseudocolour the expected rotation of the fringe pattern caused by a relative inclination in the other axis (tilt) between the target and reference surfaces.

FIG. 5 is a schematic diagram showing the layout of a stepped compensator plate solution to establish five correlative piston measurement zones in the detector.

FIG. 6 shows the apparent piston error induced by the lack of perpendicularity between the interferometer and the reference mirror, as well as the implementation of an inclination sensor in the interferometer that provides a measure of the degree of perpendicularity in which it is located.

FIG. 7 represents the magnitudes: directions of the relative piston, tip and tilt, in relation to the system.

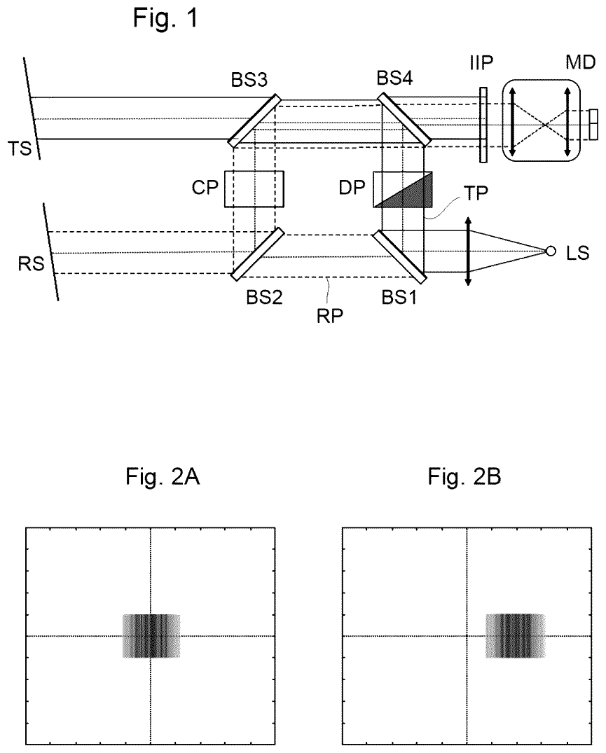

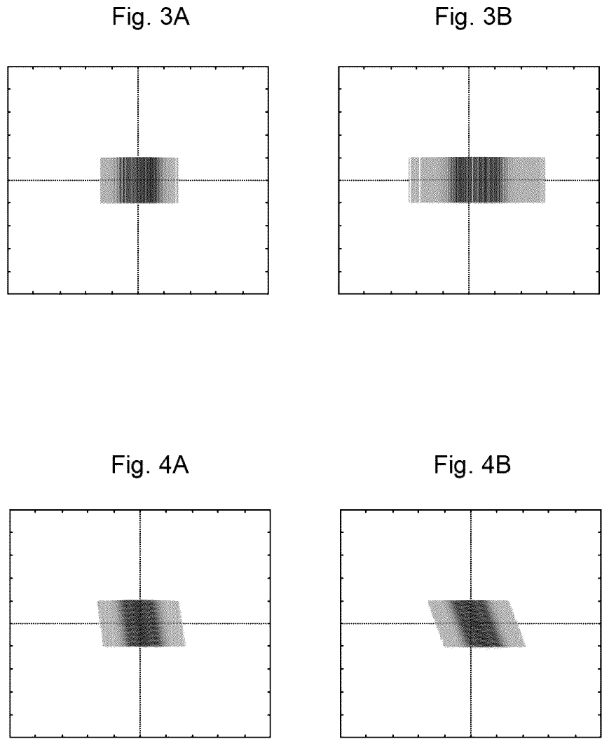

### EMBODIMENT OF THE INVENTION

As has already been indicated, a preferential implementation of the measurement system of the invention is based on the use of a modified Mach-Zehnder interferometer pointing to two adjacent almost coplanar reflective optical surfaces (RS) and (TS). As in any interferometer, this interferometer uses two light beams traveling along two different optical paths, through a system of prisms or mirrors that converge in an image plane (IIP) to form an interference pattern. In this case, a partially coherent light beam (LS) hits a first beam splitter (BS1), which splits the light into two light beams (TP, RP) going in different directions; a first light beam (RP) (represented with dashed lines) is transmitted towards a second beam splitter (BS2), aligned with the previous one, where it is also transmitted and illuminates the area of interest of the reference segment (RS). From the segment, the light is reflected back to the second beam splitter (BS2) where it is reflected towards (BS3), from where it is transmitted by (BS4) to the image capture system (MD).

Furthermore, the second beam (TP) of the same light source (represented with solid lines) is reflected by the beam splitter (BS1) towards a fourth beam splitter (BS4) and from this it is transmitted by a third beam splitter (BS3) to illuminate the target mirror segment (TS), which in turn reflects and transmits it through the beam splitters (BS3) and (BS4) to the same image capture system (MD) that captures the interference between the two beams (TP, RP).

The key modification over the classical Mach-Zehnder interferometer in the proposed system is the insertion of:
an optical component (DP) that generates a linear optical path difference (measurement tilt) in the target arm through which the beam passes (TP), and
a compensation plate (CP) in the reference path followed by the beam (RP), in order to balance the two arms of the interferometer by centring the interference pattern.

In a preferred embodiment, a double prism (DP) made with two optical glasses with different but close refractive indices is used in order to generate the desired optical path gradient. However, some other alternative solutions are possible for introducing that linear gradient, for example using a wedge prism or slightly inclining one or more of the beam splitters (BS1 to BS4) relative to each other.

In this way, a fixed interference pattern modulated by an amplitude envelope appears due to the use of partially coherent light, so that only the fringes close to the region in which the optical path difference in the two arms of the interferometer is zero (OPD=0) will be visible. Said interference pattern is projected onto a camera (MD) preferably mounted behind an afocal system.

As can be seen in FIG. 2B, the phase shift induced by the wave plate (DP) located in the target arm produces a displacement of the fringes proportional to the displacement of the piston present in the system, between the target and the reference surfaces.

Different measurement resolution values can be achieved by adapting the degree of coherence of the light source used.

In this measurement system the relative piston is represented by the position of the fringe envelope. The inclination in one axis (tip) is represented by the thickness of the fringes and can therefore be measured from the width of the modulation pattern. In turn, the inclination in the other axis (tilt) is represented by the inclination of the fringes. As these three magnitudes are shown decoupled, they can be extracted with simple morphological operations, without the need to use complex fringe processing algorithms.

In addition, this system is capable of measuring, from a single interferogram, not only the relative piston between its two arms, but also the relative inclination in two axes (tip and tilt).

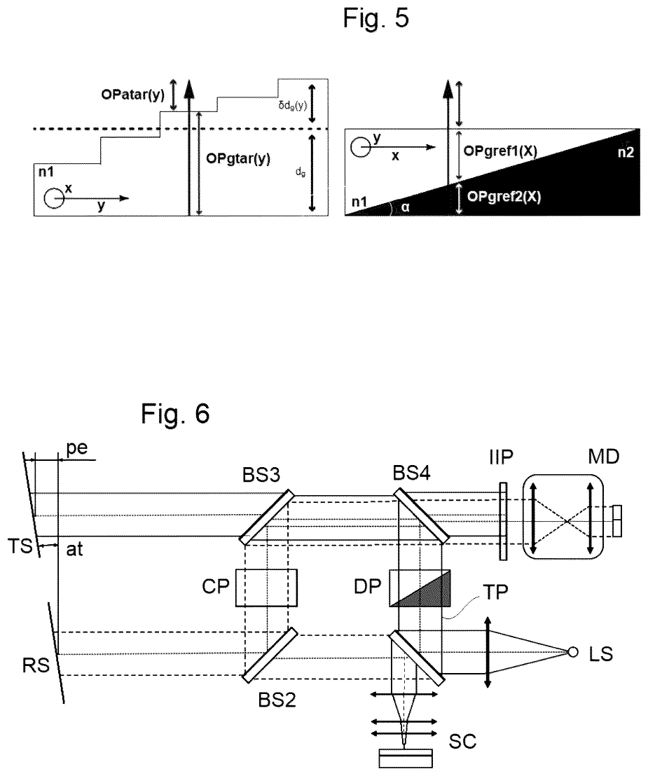

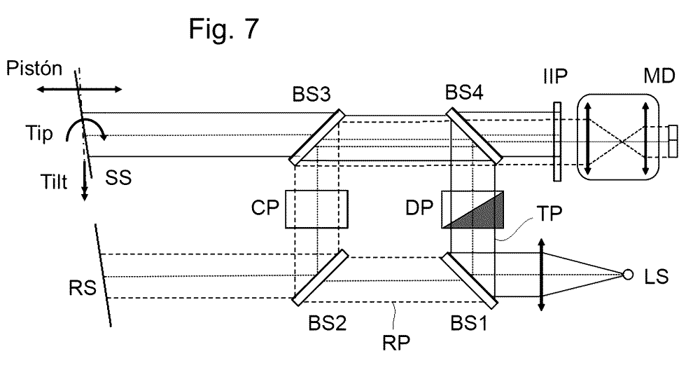

In a preferred embodiment and in order to accommodate the combination of range and resolution required in the system, the double material prism (DP) is combined with a stepped compensation plate (CP) in several different regions that introduce a constant path difference jump between them, in order to establish several correlative piston measurement zones in the detector. The measurement range can thereby be easily extended, if necessary, by using a stepped compensation plate (CP) to generate different measurement zones in the detector. (see FIG. 5). The number of zones varies depending on system specifications.

In this case, depending on the number of relative piston values, fringes will be visible through one of the regions or the other, as long as the OPD=0 position is set by the piston value being measured. The thickness “di” of each region is arranged in such a way that all possible piston values are visible in some region of the image. A certain amount of relative piston overlap between neighbouring regions can be allowed to ensure that no piston value is omitted due to tolerances or other reasons at the edges of the field. The final result is an image with different horizontal bands along the X direction where the piston value linearly displaces the OPD=0 region and subsequently the interference pattern.

The interferometer design can be adapted to the geometries, dimensions and positions of the detection areas on the reference and target surfaces.

The most significant advantage of this configuration is that the relative piston measurement is performed without the need to perform a fringe reconstruction, but only from the position of the partial coherence interferogram in the detector. This enables fast and reliable image processing algorithms, eliminates the need for complex fringe processing, is less prone to be affected by noise, and reduces piston measurement to morphological operations on the image.

The interferometer described in the previous lines is self-referenced, which enables several of its described measurement properties. However, the system lacks the ability to measure absolute inclination values which, if present, can lead to errors in the measurement of relative piston values. FIG. 6 schematically represents the apparent piston (measurement error) induced by the lack of perpendicularity between the interferometer and the reference mirror. However, this problem, which is common to all phase measurement methods, can be easily solved by integrating a two-axis absolute inclination (tip and tilt) sensor in the proposed interferometer.

A possible solution to integrate inclination sensor in the interferometer is based on the use of the collimated light transmitted by the two beam splitters (BS1 and BS2) in front of the illumination system to the reference segment and transmitted back by the second beam splitter (BS2) and reflected in the first beam splitter (BS1) being focused on one detector per target.

FIG. 6 is a schematic diagram showing the implementation of a tip inclination (SC) sensor in the interferometer, as well as a lens and an image detector that forms the red dot light, which gives us an idea of how perpendicular it is.

It is stated for the appropriate purposes that the materials, shape, size and arrangement of the elements described may be modified, as long as this does not imply an alteration of the essential features of the invention that are claimed below.

1. A non-contact optical metrology system to measure simultaneously a relative piston and a relative inclination in two axes between two reflective surfaces based on a use of a modified Mach-Zehnder interferometer pointing to two adjacent almost coplanar mirrors, with two light beams traveling along two different optical paths until converging in an interferogram image plane to form an interference pattern, the non-contact optical metrology system comprising:
a partially coherent light beam that forms two light beams going in two different paths after hitting a first beam splitter:
a first light beam that is transmitted towards a second beam splitter, aligned with the first beam splitter that illuminates an area of interest of a reference segment, the light is reflected in said segment and travels back to said second beam splitter, there it is reflected towards a third Beam Splitter where after reflection is transmitted through a fourth beam splitter to the image capture system, and
a second light beam which is reflected by the beam splitter towards the fourth beam splitter and from this it is transmitted by the third beam splitter to illuminate the target mirror segment, which in turn reflects and transmits it through the beam splitters and to the image capture system that captures an interference between the second light beam and the first light beam;
wherein:
an optical component is interposed in a target arm through which the second light beam passes, which creates a linear optical path difference between two arms of the interferometer; and
a compensation plate is interposed in a reference arm followed by the first light beam so that the phase gradient in the light is due solely to the change in the optical path introduced by the optical component;
mechanisms that generate a fixed interference pattern modulated by an amplitude envelope, in which only fringes close to a region in which the optical path difference in the two arms of the interferometer is zero, will be visible; when projecting said interference pattern in a camera, three magnitudes measured are decoupled, so the three magnitudes measured are extracted with simple morphological operations and represented by:
the relative piston by the position of the envelope of the interference pattern,
the inclination in one axis by the thickness of the fringes and can therefore be measured from the width of a modulation pattern, and
the inclination in another axis by the inclination of the fringes.

2. The non-contact optical metrology system according to claim 1, wherein the optical component that generates the optical path difference is a double prism, made up of two glasses with different but close refractive indices.

3. The non-contact optical metrology system according to claim 1, wherein the optical component that generates the optical path difference is a wedge prism.

4. The non-contact optical metrology system according to claim 1, wherein an effect of the optical component that generates the optical path difference is generated through the slight inclination of one or more of the beam splitters.

5. The non-contact optical metrology system according to claim 1, wherein the optical path difference induced by the optical component located in the target arm produces a displacement of the fringes proportional to the displacement of the piston present in the non-contact optical metrology system between the target and the reference surfaces.

6. The non-contact optical metrology system according to claim 1, wherein the measurement resolution values are a function of the degree of coherence of the light source used.

7. The non-contact optical metrology system according to claim 1, wherein the compensation plate has a stepped configuration in several different regions that introduce a constant path difference jump between said regions, in order to establish several correlative piston measurement zones in the detector, generating different measurement zones in the detector.

8. The non-contact optical metrology system according to claim 6, wherein the thickness “di” of each region is arranged in such a way that all possible piston values are visible in some region of the image.

9. The non-contact optical metrology system according to claim 6, wherein there is a certain amount of relative piston overlap between neighbouring regions to ensure that no piston value is omitted due to tolerances or other reasons at the edges of the field.

10. The non-contact optical metrology system according to claim 6, wherein the end result is an image with different horizontal bands along the X direction where the piston value linearly displaces the OPD=0 region and subsequently the interference pattern.

11. The non-contact optical metrology system according to claim 1, wherein the non-contact optical metrology system integrates an inclination sensor in the interferometer that uses the light transmitted by the two beam splitters, reflected by the reference segment and transmitted back by the second beam splitter and reflected in the first beam splitter that is focused on one detector per target, in order to be able to measure the absolute value of inclination in two axes.
